(19) United States
(12) Patent Application Publication
(10) Pub. No.: US 2025/0039726 A1
(43) Pub. Date: Jan. 30, 2025

(54) RADIO RESOURCE MANAGEMENT/RADIO LINK MONITORING MEASUREMENTS FOR REDCAP UE

(71) Applicant: Nokia Technologies Oy, Espoo (FI)

(72) Inventors: Jussi-Pekka KOSKINEN, Oulu (FI); Samuli TURTINEN, Oulu (FI); Jorma KAIKKONEN, Oulu (FI)

(21) Appl. No.: 18/919,158

(22) Filed: Oct. 17, 2024

Related U.S. Application Data
(63) Continuation of application No. 18/558,358, filed on Oct. 31, 2023.
(60) Provisional application No. 63/185,681, filed on May 7, 2021.

(51) Int. Cl. H04W 24/10

(52) U.S. Cl. CPC H04W 24/10

(57) ABSTRACT

Systems, methods, apparatuses, and computer program products for radio resource management or radio link monitoring. The method may include receiving from a network element a signal including information for a measurement relaxation. The method may also include determining whether the measurement relaxation is allowed. The method may further include performing relaxed or non-relaxed measurements based on the determination.

### RELATED APPLICATIONS:

This application is a 37 C.F.R. § 1.53(b) continuation of co-pending U.S. patent application Ser. No. 18/558,358 filed Oct. 31, 2023, which claims priority to PCT Application No. PCT/EP2022/061798, filed on May 3, 2022, which claims priority to U.S. Provisional Application No. 63/185,681 filed on May 7, 2021, which is incorporated herein by reference in its entirety.

### FIELD:

Some example embodiments may generally relate to mobile or wireless telecommunication systems, such as Long Term Evolution (LTE) or fifth generation (5G) radio access technology or new radio (NR) access technology, or other communications systems. For example, certain example embodiments may relate to apparatuses, systems, and/or methods for radio resource management or radio link monitoring measurements.

### BACKGROUND:

Examples of mobile or wireless telecommunication systems may include the Universal Mobile Telecommunications System (UMTS) Terrestrial Radio Access Network (UTRAN), Long Term Evolution (LTE) Evolved UTRAN (E-UTRAN), LTE-Advanced (LTE-A), MulteFire, LTE-A Pro, and/or fifth generation (5G) radio access technology or new radio (NR) access technology. Fifth generation (5G) wireless systems refer to the next generation (NG) of radio systems and network architecture. 5G network technology is mostly based on new radio (NR) technology, but the 5G (or NG) network can also build on E-UTRAN radio. It is estimated that NR will provide bitrates on the order of 10-20 Gbit/s or higher, and will support at least enhanced mobile broadband (eMBB) and ultra-reliable low-latency-communication (URLLC) as well as massive machine type communication (mMTC). NR is expected to deliver extreme broadband and ultra-robust, low latency connectivity and massive networking to support the Internet of Things (IOT). With IOT and machine-to-machine (M2M) communication becoming more widespread, there will be a growing need for networks that meet the needs of lower power, low data rate, and long battery life. It is noted that, in 5G, the nodes that can provide radio access functionality to a user equipment (i.e., similar to Node B in UTRAN or eNB in LTE) are named gNB when built on NR technology and named NG-eNB when built on E-UTRAN radio.

### SUMMARY:

Some example embodiments may be directed to a method. The method may include receiving from a network element a signal including information for a measurement relaxation. The method may also include determining whether the measurement relaxation is allowed based on the received information. The method may further include performing relaxed or non-relaxed measurements based on the determination.

Other example embodiments may be directed to an apparatus. The apparatus may include at least one processor and at least one memory including computer program code. The at least one memory and computer program code may also be configured to, with the at least one processor, cause the apparatus at least to receive from a network element a signal including information for a measurement relaxation. The apparatus may also be caused to determine whether the measurement relaxation is allowed based on the received information. The apparatus may further be caused perform relaxed or non-relaxed measurements based on the determination.

Other example embodiments may be directed to an apparatus. The apparatus may include means for receiving from a network element a signal including information for a measurement relaxation. The apparatus may also include means for determining whether the measurement relaxation is allowed based on the received information. The apparatus may further include means for performing relaxed or non-relaxed measurements based on the determination.

In accordance with other example embodiments, a non-transitory computer readable medium may be encoded with instructions that may, when executed in hardware, perform a method. The method may include receiving from a network element a signal including information for a measurement relaxation. The method may also include determining whether the measurement relaxation is allowed based on the received information. The method may further include performing relaxed or non-relaxed measurements based on the determination.

Other example embodiments may be directed to a computer program product that performs a method. The method may also include receiving from a network element a signal including information for a measurement relaxation. The method may also include determining whether the measurement relaxation is allowed based on the received information. The method may further include performing relaxed or non-relaxed measurements based on the determination.

Other example embodiments may be directed to an apparatus that may include circuitry configured to measure, at the apparatus, a radio signal. The apparatus may also include circuitry configured to receive from a network element a signal including information for a measurement relaxation. The apparatus may also include circuitry configured to determine whether the radio link monitoring measurement relaxation or the radio resource management measurement relaxation is allowed based on the received information. The apparatus may further include circuitry configured to perform relaxed or non-relaxed measurements based on the determination.

Certain example embodiments may be directed to a method. The method may include configuring a user equipment by transmitting to the user equipment a signal including information on whether a radio link monitoring measurement relaxation or a radio resource management measurement relaxation is allowed.

Other example embodiments may be directed to an apparatus. The apparatus may include at least one processor and at least one memory including computer program code. The at least one memory and computer program code may be configured to, with the at least one processor, cause the apparatus at least to configure a user equipment by transmitting to the user equipment a signal including information on whether a radio link monitoring measurement relaxation or a radio resource management measurement relaxation is allowed.

Other example embodiments may be directed to an apparatus. The apparatus may include means for means for configuring a user equipment by transmitting to the user equipment a signal including information on whether a radio link monitoring measurement relaxation or a radio resource management measurement relaxation is allowed.

In accordance with other example embodiments, a non-transitory computer readable medium may be encoded with instructions that may, when executed in hardware, perform a method. The method may include configuring a user equipment by transmitting to the user equipment a signal including information on whether a radio link monitoring measurement relaxation or a radio resource management measurement relaxation is allowed.

Other example embodiments may be directed to a computer program product that performs a method. The method may include configuring a user equipment by transmitting to the user equipment a signal including information on whether a radio link monitoring measurement relaxation or a radio resource management measurement relaxation is allowed.

Other example embodiments may be directed to an apparatus that may include circuitry configured to configure a user equipment by transmitting to the user equipment a signal including information on whether a radio link monitoring measurement relaxation or a radio resource management measurement relaxation is allowed.

### BRIEF DESCRIPTION OF THE DRAWINGS:

For proper understanding of example embodiments, reference should be made to the accompanying drawings, wherein:

FIG. 1 illustrates an example flow diagram of a method, according to certain example embodiments.

FIG. 2 illustrates an example flow diagram of another method, according to certain example embodiments.

FIG. 3(a) illustrates an apparatus, according to certain example embodiments.

FIG. 3(b) illustrates another apparatus, according to certain example embodiments.

### DETAILED DESCRIPTION:

It will be readily understood that the components of certain example embodiments, as generally described and illustrated in the figures herein, may be arranged and designed in a wide variety of different configurations. The following is a detailed description of some example embodiments of systems, methods, apparatuses, and computer program products for radio resource management or radio link monitoring relaxation for reduced capability user equipment.

The features, structures, or characteristics of example embodiments described throughout this specification may be combined in any suitable manner in one or more example embodiments. For example, the usage of the phrases “certain embodiments,” “an example embodiment,” “some embodiments,” or other similar language, throughout this specification refers to the fact that a particular feature, structure, or characteristic described in connection with an embodiment may be included in at least one embodiment. Thus, appearances of the phrases “in certain embodiments,” “an example embodiment,” “in some embodiments,” “in other embodiments,” or other similar language, throughout this specification do not necessarily refer to the same group of embodiments, and the described features, structures, or characteristics may be combined in any suitable manner in one or more example embodiments.

3^{rd} Generation Partnership Project (3GPP) Rel-17 discusses usage scenarios identified for 5G that may include enhanced mobile broadband (eMBB), massive machine-type communication (mMTC), and ultra-reliable and low latency communication (URLLC). Another area may include time sensitive communication (TSC) including. For example, mMTC, URLLC, and TSC may be associated with novel Internet of Things (IOT) use cases that are targeted in vertical industries. Further, the eMBB, mMTC, URLLC, and TSC use cases may be supported in the same network.

3GPP has confirmed that NB-IOT and LTE-MTC (eMTC) fulfills the IMT-2020 requirements for mMTC, and can be certified as 5G technologies. For URLLC support, Rel-15 introduced URLLC features for both LTE and NR, and NR URLLC may further be enhanced in Rel-16 within the enhanced URLLC (CURLLC) and industrial IoT work items. Rel-16 also provides support for time-sensitive networking (TSN) and 5G integration for TSC use cases.

Certain categories of mid-range use cases have been identified in 3GPP where some NR enhancements may be motivated. For example, 5G may enable connected industries, and 5G connectivity may serve as a catalyst for industrial transformation and digitalization. Similar to connected industries, 3GPP describes smart city use cases and requirements for such use cases. 3GPP also describes mid-range use cases where NR enhancements may be motivated to also include use cases for wearables and medical monitoring devices for use in public safety.

As a baseline, 3GPP describes certain requirements for the above-described use cases. For instance, such requirements may include generic requirements and use case specific requirements. Techniques for UE complexity reduction, coverage recovery, and UE power saving for these use cases have been studied in the reduced capacity (RedCap) items documented in TR 38.875.

Reduced maximum UE bandwidth may be characterized with a maximum bandwidth of a frequency range 1 (FR1) RedCap UE during and after initial access at 20 MHZ, or a maximum bandwidth of a frequency range 2 (FR2) RedCap UE during and after initial access at 100 MHZ. Support for reduced minimum number of Rx branches may also be provided. For instance, for frequency bands where a legacy NR UE may be equipped with a minimum of two Rx antenna ports, and the minimum number of Rx branches supported by the specification for a RedCap UE may be one. The specification may also support two Rx branches for a RedCap UE in these bands. Furthermore, for frequency bands where a legacy NR UE (other than 2-Rx vehicular UE) may be needed to be equipped with a minimum of four Rx antenna ports, the minimum number of Rx branches supported by the specification for a RedCap UE may be one. The specification may also support two Rx branches for a RedCap UE in these bands. Additionally, 3GPP specifics a means by which the gNB may know the number of Rx branches of the UE.

Furthermore, support for a maximum number of downlink (DL) multiple-input and multiple-output (MIMO) layers may be provided. For a RedCap UE with one Rx branch, one DL MIMO layer may be supported. On the other hand, for a RedCap UE with two Rx branches, two DL MIMO layers may be supported.

3GPP has specified support for relaxed maximum modulation order. For instance, support of 256QAM in DL may be optional (instead of mandatory) for an FRI RedCap UE. Support may also be provided for duplex operation(s) including, for example, half duplex operation (HD-FDD) type A with the minimum specification impact. Other specifications may be provided including, for example, for defining the RedCap UE type. This may include defining certain capabilities for RedCap UE identification, for constraining the use of those RedCap capabilities for RedCap UEs, and for preventing RedCap UEs from using capabilities not intended for RedCap UEs. Such capabilities may include, for example, at least carrier aggregation, dual connectivity, and wider bandwidths. The existing UE capability framework may be used, and changes to capability signaling may be specified if necessary.

3GPP has also described certain functionalities that may enable RedCap UEs to be explicitly identifiable to networks through an early identification in Msgl and/or Msg3, and MsgA if supported, including the ability for the early indication to be configurable by the network. In addition, system information indication may be specified to indicate whether or not a RedCap UE may camp on the cell/frequency. It may be possible for the indication to be specific to the number of Rx branches of the UE. Additionally, necessary updates of UE capabilities and RRC parameters may be specified along with support for extended discontinuous reception (DRX) enhancements for RedCap UEs. For instance, such support may include extended DRX for RRC inactive and idle with eDRX cycles up to 10.24 s, without using a paging transmission window (PTW) and paging hyperframe (PH), and with common design (e.g., common set of eDRX values) between radio resource control (RRC) inactive and idle states. The extended DRX enhancements may also include extended DRX for RRC inactive and idle states with eDRX cycles up to 10485.76 s. In addition, it may decided which node(s) may configure eDRX in RRC_Idle and RRC_Inactive states.

Certain alternatives identified in RedCap SI may consider radio resource management (RRM) relaxations for neighboring cells for RedCap devices (RRC_Idle/Inactive/Connected). In addition, enabling/disabling of RRM relaxation may be under the network's control.

Furthermore, 3GPP has discussed certain RRM relaxations. For instance, it may be assumed that a UE may use some reference signal received power or reference signal received quality (RSRP/RSRQ) based criteria. In addition, at least for RRC Idle or Inactive states, a measurement-based stationarity criterion may be configured separately from low-mobility criterion for UEs supporting the feature. The same algorithm may be used in low-mobility criterion but with its own specific set of thresholds, and/or a combination of low-mobility criterion and/or beam-change based criterion. In addition, the network may configure stationarity criterion/criteria together with a not-at-cell-edge criterion to trigger RRM relaxations in RRC Idle/Inactive for UEs supporting the feature. 3GPP describes low mobility not-at-cell-edge relaxation criterions. For instance, the relaxed measurement criterion for a UE with low mobility may be fulfilled when (Srxlev_{Ref}−Srxlev)<S_{SearchDeltaP}, where Srxlev represents the current Srxlev value (e.g., cell selection Rx level value) of the serving cell (dB), and SrxlevRef represents the reference Srxlev value of the serving cell (dB). The reference Srxlev value of the serving cell (dB) may be set after selecting or reselecting a new cell, or if Srxlev−Srxlev_{Ref}) >0, or if the relaxed measurement criterion has not been met for T_{SearchDeltaP}. The UE may set the value of Srxlev_{Ref} to the current Srxlev value of the serving cell.

When the UE is not at the cell edge, the relaxed measurement criterion for the UE may be fulfilled when Srxlev>S_{SearchThresholdP}, and Squal>S_{SearchThresholdQ}, if S_{SearchThresholdQ} is configured, where Srxlev represents current Srxlev value of the serving cell (dB), and Squal represents a Squal value (c.g., cell selection quality value) of the serving cell (dB). As specified in 3GPP, a UE capability report may at least be used according to the existing framework to indicate (implicitly or explicitly) the number of Rx branches. However, it may be desirable to determine whether/how to support an carlier indication of RedCap UEs with a certain number of Rx branches by Msg1 and/or Msg3,and MsgA.

In certain cases, RedCap devices may have a reduced number of Rx branches and/or Rx ports, which may impact RRM measurement accuracy and cell coverage for such UEs. Thus, in certain example embodiments, such an impact may be accounted in RRM relaxation criteria evaluation. According to certain example embodiments, the UEs' reduced capabilities may be accounted for in the radio resource management (RRM) or radio link monitoring (RLM) relaxation criteria and/or RRM relaxation criteria evaluation. In some example embodiments, the UE with reduced capabilities may not be allowed to relax RRM or RLM measurements. In certain example embodiments, the UE may not be allowed to relax RRM or RLM measurements when the UE is moving, mobile, not stationary, when the UE is close to the cell edge, when cell power/quality is low e.g. relative to an associated threshold, or when RSRP measurements are not static (i.e., changing) or when beam changes are occurring or are occurring frequently. For instance, in certain example embodiments, the UE may ignore RRM or RLM relaxation configuration received via system information. According to certain example embodiments, both RLM and RRM measurement relaxation may be achieved both in a time and frequency manner. For instance, measurements may be done less often or more infrequently than when relaxation is not applied, for example, by using different measurement period(s) or less or lower number of frequencies can be measured. In addition, measurement accuracy requirements may be relaxed for these measurements. By implementing these methods, it may be possible for the UE to save battery power.

In some example embodiments, the network (NW) may signal to the UE with certain capabilities such as, for example, with reduced capabilities whether or not relaxed RRM or RLM measurements are allowed. According to certain example embodiments, relaxed RRM or RLM measurements may not be allowed when the UE is at the cell edge, when UE measurement reports indicate low RSRP/RSRQ/CQI values relative to an associated threshold, beam changes are frequently occurring, the UE is not stationary, the UE is moving, and/or RSRP is changing (c.g., becoming better or worse). According to other example embodiments, when the UE with reduced capabilities is not experiencing these situations, relaxation of RRM or RLM measurements may be allowed. In certain example embodiments, the RRM or RLM relaxation criteria for non-RedCap UEs may be adjusted for UEs with reduced capabilities. According to certain example embodiments, the adjustment may include one or more of adding or subtracting an offset or a multiplier for RRM or RLM relaxation parameters such as S_{searchDeltaP}, T_{SearchDeltaP}, S_{SearchThresholdP}, and S_{SearchThresholdQ}, where S_{SearchDeltaP} specifies the threshold (in dB) on Srxlev variation for relaxed measurement, T_{SearchDeltaP} specifies the time period over which the Srxlev variation is evaluated for relaxed measurement, S_{SearchThresholdP} specifies the Srxlev threshold (in dB) for relaxed measurement, and S_{SearchThresholdQ} specifies the Squal threshold (in dB) for relaxed measurement. According to some example embodiments, the offset value may be, for example, a number of seconds for T_{SearchDeltaP} and dBs for S_{SearchDeltaP}, S_{SearchThresholdP}, and S_{SearchThresholdQ}. In certain example embodiments, the NW may configure the RedCap UE type and/or number of Rx branch specific adjustments. According to certain example embodiments, certain RedCap UE types may support different functionalities than other types of RedCap UEs. For instance, the different functionalities may include different number of Rx branches, different number of Rx ports, different number of Tx branches, reduced Tx power class, reduced processing capabilities or any L1 or L2 or RRC capabilities, or processing power.

According to certain example embodiments, the RRM or RLM relaxation criteria for non-RedCap UEs may be adjusted for relaxed measurement criterion for UEs with low mobility, relaxed measurement criterion for UEs not at the cell edge, or for any new criterion to be defined. According to other example embodiments, the reduced capabilities described herein may include one or more of Rx branches, Rx ports, Tx branches, reduced Tx power class, reduced processing capabilities, and/or RedCap UE types. In certain example embodiments, the above-described signaling from the NW to the UE may be provided via dedicated and/or broadcast signaling. For instance, according to certain example embodiments, the configuration may be done UE specifically or commonly to RedCap UEs, respectively. For instance, in certain example embodiments, certain configurations may be provided both via dedicated and/or broadcast signaling. Dedicated signaling may be for one UE, and broadcast signaling may be for multiple RedCap UEs on the cell. In other example embodiments, the RRM or RLM relaxation above may be targeted in one or more RRC states including, for example, IDLE, INACTIVE, and CONNECTED states.

According to certain example embodiments, stationary property based on subscription information to allow RRM relaxation may be considered. Without network control, however, subscription information based RRM/RLM measurement relaxation may be misused by the UE (i.e. UEs may autonomously relax the RRM measurements which may be problematic from the NW point of view in all RRC states), but especially in RRC_CONNECTED leading possibly to radio link failures and handover failures.

According to certain example embodiments, NW indicates whether RRM/RLM relaxation is allowed based on subscription information (e.g. low mobile, stationary) about UE mobility. In certain example embodiments, the UE may or may not be allowed to relax by default based on subscription information (e.g. low mobile, stationary). In certain example embodiments, the indication may be e.g. allowed/disallowed (i.e. further criteria for “subscription based stationary” UEs).

According to certain example embodiments, RRM/RLM relaxation may be allowed based on subscription information only if further criteria is fulfilled. In certain example embodiments, the further criteria can be e.g. new RSRP threshold (e.g. not-at-cell-edge), RSRP variation threshold (e.g. low mobile), beam based condition, offset to the REL16 RSRP threshold (i.e. not-at-cell-edge) and/or offset RSRP variation threshold (low mobile). In one example embodiment, different RRM/RLM measurement relaxation criterions may be configured for subscription based stationary UEs and other UEs. In one example embodiment, RRM/RLM relaxation parameters like SSearchDeltaP, TSearchDeltaP, SSearchThresholdP, SSearchThresholdQ are scaled by subscription based stationary UEs e.g. by adding/subtracting offset or multiplier. Offset value may be, for example, seconds for TSearchDeltaP and dBs for other above parameters. In certain example embodiments, the further criteria above may be be UE capability related, for example, in terms of UE Rx/Tx branches/ports, Tx power class, processing capabilities, RedCap UE types. In some examples, if the UE is 1 RX (and/or 1 TX) UE, the UE may not be allowed to relax based on subscription information; however, in some examples, if the UE is 2 RX UE, the relaxation may be allowed.

According to certain example embodiments, the indication may be provided via dedicated and/or broadcast signaling. In some example embodiments, the indication may be provided, for example, via NAS/RRC/MAC/PHY layer signaling. In some example embodiments, the above may be related to one or more of the following RRC states: IDLE, INACTIVE, CONNECTED.

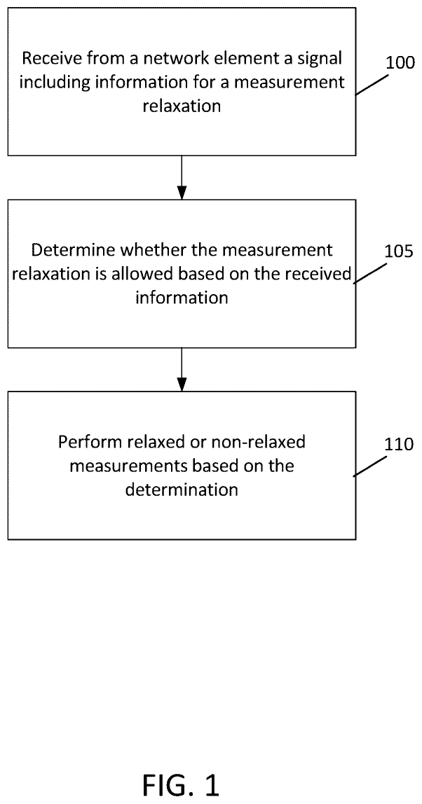

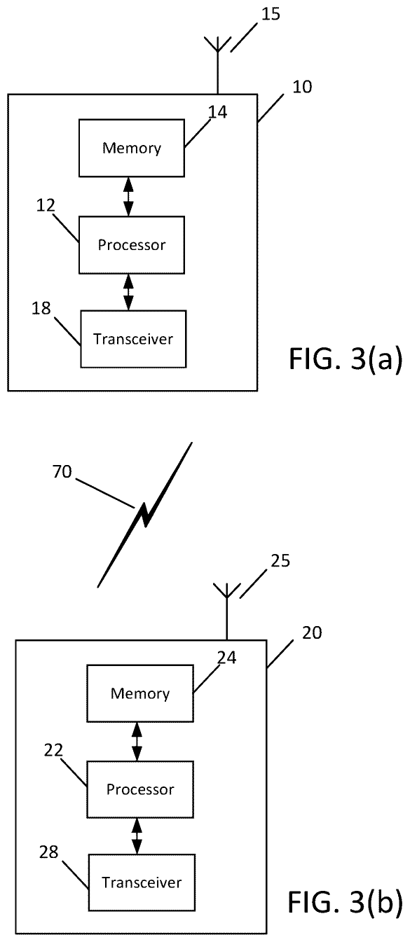

FIG. 1 illustrates an example flow diagram of a method, according to certain example embodiments. In an example embodiment, the method of FIG. 1 may be performed by a network entity, network node, or a group of multiple network elements in a 3GPP system, such as LTE or 5G-NR. For instance, in an example embodiment, the method of FIG. 1 may be performed by a UE, for instance, similar to apparatus 10 illustrated in FIG. 3(a).

According to certain example embodiments, the method of FIG. 1 may include, at 100, receiving from a network element a signal including information for a measurement relaxation. The method may also include, at 105, determining whether the measurement relaxation is allowed based on the received information. The method may further include, at 110, performing relaxed or non-relaxed measurements based on the determination.

According to certain example embodiments, the method may also include determining whether a user equipment is a reduced capability user equipment or a non-reduced capability user equipment. According to other example embodiments, the method may also include ignoring the information when the user equipment is a reduced capability user equipment. In certain example embodiments, the signal may be received by the reduced capability user equipment. In other example embodiments, the signal may be received by the non-reduced capability user equipment. According to certain example embodiments, the measurement relaxation may not be allowed when the user equipment is mobile, near a cell edge, when a cell power or quality is low, or when a reference signal received power measurement is not static. In certain example embodiments, the measurement relaxation may be allowed when a threshold is or is not met, or allowed based on subscription information about a mobility of the user equipment. In other example embodiments, the subscription information may include an indication that the user equipment is stationary. In some example embodiments, the threshold may include a reference signal received power threshold, a reference signal received power variation threshold, or a beam change count threshold. According to other example embodiments, the measurement relaxation may be achieved both in a time and frequency manner. According to further example embodiments, the reduced capabilities may include one or more of Rx branches, Rx ports, Tx branches, reduced Tx power class, reduced processing capabilities, or reduced capability user equipment types. In certain example embodiments, the signal may be received via dedicated signaling or broadcast signaling. In some example embodiments, the information may be targeted toward one or more radio resource control states comprising an idle state, an inactive state, and a connected state.

According to certain example embodiments, the measurement relaxation may be a radio link monitoring measurement relaxation or a radio resource management measurement. According to other example embodiments, the information may include radio link monitoring or radio resource management relaxation criteria for the user equipment with non-reduced capabilities. According to further example embodiments, the method may also include receiving configuration of an adjustment of the radio link monitoring or radio resource management relaxation criteria, and adjusting radio link monitoring or radio resource management relaxation criteria based on the configuration. In some example embodiments, the adjustment may include one or more of adding or subtracting an offset or a multiplier for radio link monitoring or radio resource management relaxation parameters.

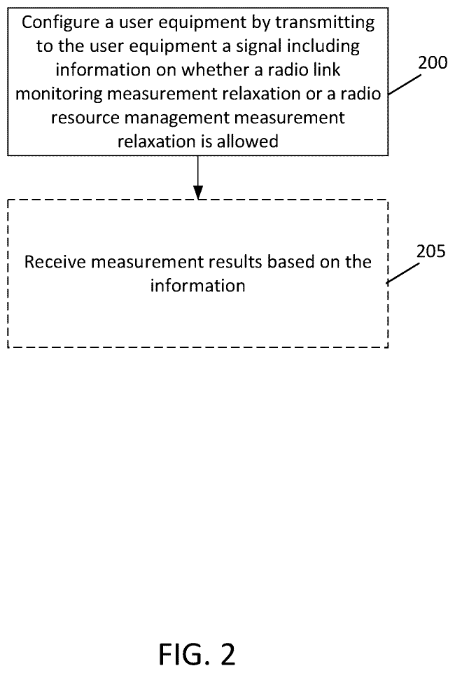

FIG. 2 illustrates an example flow diagram of another method, according to certain example embodiments. In an example embodiment, the method of FIG. 2 may be performed by a network entity, network node, or a group of multiple network elements in a 3GPP system, such as LTE or 5G-NR. For instance, in an example embodiment, the method of FIG. 2 may be performed by a BS, for instance, similar to apparatus 20 illustrated in FIG. 3(b).

According to certain example embodiments, the method of FIG. 2 may include, at 200, configuring a user equipment by transmitting to the user equipment a signal including information on whether a radio link monitoring measurement relaxation or a radio resource management measurement relaxation is allowed. The method may also include, at 205, receiving measurement results based on the information. According to certain example embodiments, the measurement results may be received when the user equipment is in an RRC_CONNECTED state. In other example embodiments, the measurement results may not be received by the user equipment when the user equipment is in an RRC_IDLE state or an RRC_INACTIVE state.

According to certain example embodiments, the radio link monitoring measurement relaxation or the radio resource management measurement relaxation may not be allowed when the user equipment is mobile, near a cell edge, when a cell power or quality is low, or when a reference signal received power measurement is not static. According to other example embodiments, the information may be transmitted to a user equipment that has reduced capabilities. According to some example embodiments, the signal may be transmitted via dedicated signaling or broadcast signaling.

In certain example embodiments, the information may be targeted toward one or more radio resource control states comprising an idle state, an inactive state, and a connected state. In other example embodiments, the method may also include adjusting measurement configuration criteria for a user equipment with reduced capabilities. According to certain example embodiments, the adjustment may include adjusting one or more of an addition or subtraction offset or multiplier for radio resource management or radio link monitoring relaxation parameters. According to other example embodiments, the adjustment may be performed for a relaxed measurement criterion for a user equipment with a low mobility, for a relaxed measurement criterion for a user equipment located away from a cell edge, or for a new criterion to be defined. In some example embodiments, the method may also include configuring a reduced capability user equipment type or a number of Rx branch specific adjustments.

FIG. 3(a) illustrates an apparatus 10 according to certain example embodiments. In certain example embodiments, apparatus 10 may be a node or element in a communications network or associated with such a network, such as a UE, mobile equipment (ME), mobile station, mobile device, stationary device, or other similar device. It should be noted that one of ordinary skill in the art would understand that apparatus 10 may include components or features not shown in FIG. 3(a).

In some example embodiments, apparatus 10 may include one or more processors, one or more computer-readable storage medium (for example, memory, storage, or the like), one or more radio access components (for example, a modem, a transceiver, or the like), and/or a user interface. In some example embodiments, apparatus 10 may be configured to operate using one or more radio access technologies, such as GSM, LTE, LTE-A, NR, 5G, WLAN, WiFi, NB-IOT, Bluetooth, NFC, MulteFire, and/or any other radio access technologies. It should be noted that one of ordinary skill in the art would understand that apparatus 10 may include components or features not shown in FIG. 3(a).

As illustrated in the example of FIG. 3(a), apparatus 10 may include or be coupled to a processor 12 for processing information and executing instructions or operations. Processor 12 may be any type of general or specific purpose processor. In fact, processor 12 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 12 is shown in FIG. 3(a), multiple processors may be utilized according to other example embodiments. For example, it should be understood that, in certain example embodiments, apparatus 10 may include two or more processors that may form a multiprocessor system (e.g., in this case processor 12 may represent a multiprocessor) that may support multiprocessing.

According to certain example embodiments, the multiprocessor system may be tightly coupled or loosely coupled (e.g., to form a computer cluster).

Processor 12 may perform functions associated with the operation of apparatus 10 including, as some examples, precoding of antenna gain/phase parameters, encoding and decoding of individual bits forming a communication message, formatting of information, and overall control of the apparatus 10, including processes illustrated in FIG. 1.

Apparatus 10 may further include or be coupled to a memory 14 (internal or external), which may be coupled to processor 12, for storing information and instructions that may be executed by processor 12. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 14 can be comprised of any combination of random access memory (RAM), read only memory (ROM), static storage such as a magnetic or optical disk, hard disk drive (HDD), or any other type of non-transitory machine or computer readable media. The instructions stored in memory 14 may include program instructions or computer program code that, when executed by processor 12, enable the apparatus 10 to perform tasks as described herein.

In certain example embodiments, apparatus 10 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 12 and/or apparatus 10 to perform any of the methods illustrated in FIG. 1.

In some example embodiments, apparatus 10 may also include or be coupled to one or more antennas 15 for receiving a downlink signal and for transmitting via an uplink from apparatus 10. Apparatus 10 may further include a transceiver 18 configured to transmit and receive information.

The transceiver 18 may also include a radio interface (e.g., a modem) coupled to the antenna 15. The radio interface may correspond to a plurality of radio access technologies including one or more of GSM, LTE, LTE-A, 5G, NR, WLAN, NB-IOT, Bluetooth, BT-LE, NFC, RFID, UWB, and the like. The radio interface may include other components, such as filters, converters (for example, digital-to-analog converters and the like), symbol demappers, signal shaping components, an Inverse Fast Fourier Transform (IFFT) module, and the like, to process symbols, such as OFDMA symbols, carried by a downlink or an uplink.

For instance, transceiver 18 may be configured to modulate information on to a carrier waveform for transmission by the antenna(s) 15 and demodulate information received via the antenna(s) 15 for further processing by other elements of apparatus 10. In other example embodiments, transceiver 18 may be capable of transmitting and receiving signals or data directly. Additionally or alternatively, in some example embodiments, apparatus 10 may include an input and/or output device (I/O device). In certain example embodiments, apparatus 10 may further include a user interface, such as a graphical user interface or touchscreen.

In certain example embodiments, memory 14 stores software modules that provide functionality when executed by processor 12. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software. According to certain example embodiments, apparatus 10 may optionally be configured to communicate with apparatus 20 via a wireless or wired communications link 70 according to any radio access technology, such as NR.

According to certain example embodiments, processor 12 and memory 14 may be included in or may form a part of processing circuitry or control circuitry. In addition, in some example embodiments, transceiver 18 may be included in or may form a part of transceiving circuitry.

For instance, in certain example embodiments, apparatus 10 may be controlled by memory 14 and processor 12 to receive from a network element a signal including information for a measurement relaxation. Apparatus 10 may also be controlled by memory 14 and processor 12 to determine whether the measurement relaxation is allowed based on the received information. Apparatus 10 may further be controlled by memory 14 and processor 12 to perform relaxed or non-relaxed measurements based on the determination.

FIG. 3(b) illustrates an apparatus 20 according to certain example embodiments. In certain example embodiments, the apparatus 20 may be a node or element in a communications network or associated with such a network, such as a base station, a Node B, an evolved Node B (eNB), 5G Node B or access point, next generation Node B (NG-NB or gNB), NM, BS, and/or WLAN access point, associated with a radio access network (RAN), such as an LTE network, 5G or NR. It should be noted that one of ordinary skill in the art would understand that apparatus 20 may include components or features not shown in FIG. 3(b).

As illustrated in the example of FIG. 3(b), apparatus 20 may include a processor 22 for processing information and executing instructions or operations. Processor 22 may be any type of general or specific purpose processor. For example, processor 22 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 22 is shown in FIG. 3(b), multiple processors may be utilized according to other example embodiments. For example, it should be understood that, in certain example embodiments, apparatus 20 may include two or more processors that may form a multiprocessor system (c.g., in this case processor 22 may represent a multiprocessor) that may support multiprocessing. In certain example embodiments, the multiprocessor system may be tightly coupled or loosely coupled (e.g., to form a computer cluster).

According to certain example embodiments, processor 22 may perform functions associated with the operation of apparatus 20, which may include, for example, precoding of antenna gain/phase parameters, encoding and decoding of individual bits forming a communication message, formatting of information, and overall control of the apparatus 20, including processes illustrated in FIG. 2.

Apparatus 20 may further include or be coupled to a memory 24 (internal or external), which may be coupled to processor 22, for storing information and instructions that may be executed by processor 22. Memory 24 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 24 can be comprised of any combination of random access memory (RAM), read only memory (ROM), static storage such as a magnetic or optical disk, hard disk drive (HDD), or any other type of non-transitory machine or computer readable media. The instructions stored in memory 24 may include program instructions or computer program code that, when executed by processor 22, enable the apparatus 20 to perform tasks as described herein.

In certain example embodiments, apparatus 20 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 22 and/or apparatus 20 to perform the methods illustrated in FIG. 2.

In certain example embodiments, apparatus 20 may also include or be coupled to one or more antennas 25 for transmitting and receiving signals and/or data to and from apparatus 20. Apparatus 20 may further include or be coupled to a transceiver 28 configured to transmit and receive information. The transceiver 28 may include, for example, a plurality of radio interfaces that may be coupled to the antenna(s) 25. The radio interfaces may correspond to a plurality of radio access technologies including one or more of GSM, NB-IOT, LTE, 5G, WLAN, Bluetooth, BT-LE, NFC, radio frequency identifier (RFID), ultrawideband (UWB), MulteFire, and the like. The radio interface may include components, such as filters, converters (for example, digital-to-analog converters and the like), mappers, a Fast Fourier Transform (FFT) module, and the like, to generate symbols for a transmission via one or more downlinks and to receive symbols (for example, via an uplink).

As such, transceiver 28 may be configured to modulate information on to a carrier waveform for transmission by the antenna(s) 25 and demodulate information received via the antenna(s) 25 for further processing by other elements of apparatus 20. In other example embodiments, transceiver 18 may be capable of transmitting and receiving signals or data directly. Additionally or alternatively, in some example embodiments, apparatus 20 may include an input and/or output device (I/O device).

In certain example embodiment, memory 24 may store software modules that provide functionality when executed by processor 22. The modules may include, for example, an operating system that provides operating system functionality for apparatus 20. The memory may also store one or more functional modules, such as an application or program, to provide additional functionality for apparatus 20. The components of apparatus 20 may be implemented in hardware, or as any suitable combination of hardware and software.

According to some example embodiments, processor 22 and memory 24 may be included in or may form a part of processing circuitry or control circuitry. In addition, in some example embodiments, transceiver 28 may be included in or may form a part of transceiving circuitry.

As used herein, the term “circuitry” may refer to hardware-only circuitry implementations (e.g., analog and/or digital circuitry), combinations of hardware circuits and software, combinations of analog and/or digital hardware circuits with software/firmware, any portions of hardware processor(s) with software (including digital signal processors) that work together to cause an apparatus (e.g., apparatus 10 and 20) to perform various functions, and/or hardware circuit(s) and/or processor(s), or portions thereof, that use software for operation but where the software may not be present when it is not needed for operation. As a further example, as used herein, the term “circuitry” may also cover an implementation of merely a hardware circuit or processor (or multiple processors), or portion of a hardware circuit or processor, and its accompanying software and/or firmware. The term circuitry may also cover, for example, a baseband integrated circuit in a server, cellular network node or device, or other computing or network device.

In other example embodiments, apparatus 20 may be controlled by memory 24 and processor 22 to configure a user equipment by transmitting to the user equipment a signal including information on whether a radio link monitoring measurement relaxation or a radio resource management measurement relaxation is allowed. Apparatus 20 may further be controlled by memory 24 and processor 22 to receive measurement results based on the information. According to certain example embodiments, the measurement results may be received when the user equipment is in an RRC_CONNECTED state. In other example embodiments, the measurement results may not be received by the user equipment when the user equipment is in an RRC_IDLE state or an RRC_INACTIVE state.

In some example embodiments, an apparatus (e.g., apparatus 10 and/or apparatus 20) may include means for performing a method, a process, or any of the variants discussed herein. Examples of the means may include one or more processors, memory, controllers, transmitters, receivers, and/or computer program code for causing the performance of the operations.

Certain example embodiments may be directed to an apparatus that includes means for receiving from a network element a signal including information for a measurement relaxation. The apparatus may also include means for determining whether the measurement relaxation is allowed based on the received information. The apparatus may further include means for performing relaxed or non-relaxed measurements based on the determination.

Other example embodiments may be directed to an apparatus that includes means for configuring a user equipment by transmitting to the user equipment a signal including information on whether a radio link monitoring measurement relaxation or a radio resource management measurement relaxation is allowed. The apparatus may further include means for receiving measurement results based on the information. According to certain example embodiments, the measurement results may be received when the user equipment is in an RRC_CONNECTED state. In other example embodiments, the measurement results may not be received by the user equipment when the user equipment is in an RRC_IDLE state or an RRC_INACTIVE state.

Certain example embodiments described herein provide several technical improvements, enhancements, and/or advantages. In some example embodiments, it may be possible for the NW to control RRM or RLM relaxations differently for RedCap and non-RedCap UEs, or UEs with reduced capability (e.g., in the number of Rx chains). In other example embodiments, it may be possible to provide stricter (less relaxed) RRM or RLM relaxations that may be configured for RedCap UEs, or UEs with reduced capability (e.g., in the number of RX chains). According to further example embodiments, the NW may disable or enable RRM or RLM relaxations for RedCap UEs. According to other example embodiments, measurement relaxation for RedCap devices may be achieved in a controlled manner so that relaxation may be allowed, making UE power saving possible, and at the same time, cell reselections and handovers may not be significantly delayed.

In some example embodiments, an apparatus may include or be associated with at least one software application, module, unit or entity configured as arithmetic operation(s), or as a program or portions of programs (including an added or updated software routine), which may be executed by at least one operation processor or controller. Programs, also called program products or computer programs, including software routines, applets and macros, may be stored in any apparatus-readable data storage medium and may include program instructions to perform particular tasks. A computer program product may include one or more computer-executable components which, when the program is run, are configured to carry out some example embodiments. The one or more computer-executable components may be at least one software code or portions of code. Modifications and configurations required for implementing the functionality of an example embodiment may be performed as routine(s), which may be implemented as added or updated software routine(s). In one example, software routine(s) may be downloaded into the apparatus.

As an example, software or a computer program code or portions of it may be in a source code form, object code form, or in some intermediate form, and it may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers. The computer readable medium or computer readable storage medium may be a non-transitory medium.

In other example embodiments, the functionality may be performed by hardware or circuitry included in an apparatus (e.g., apparatus 10 or apparatus 20), for example through the use of an application specific integrated circuit (ASIC), a programmable gate array (PGA), a field programmable gate array (FPGA), or any other combination of hardware and software. In yet another example embodiment, the functionality may be implemented as a signal, a non-tangible means that can be carried by an electromagnetic signal downloaded from the Internet or other network.

According to certain example embodiments, an apparatus, such as a node, device, or a corresponding component, may be configured as circuitry, a computer or a microprocessor, such as single-chip computer element, or as a chipset, including at least a memory for providing storage capacity used for arithmetic operation and an operation processor for executing the arithmetic operation.

One having ordinary skill in the art will readily understand that the invention as discussed above may be practiced with procedures in a different order, and/or with hardware elements in configurations which are different than those which are disclosed. Therefore, although the invention has been described based upon these example embodiments, it would be apparent to those of skill in the art that certain modifications, variations, and alternative constructions would be apparent, while remaining within the spirit and scope of example embodiments. Although the above embodiments refer to 5G NR and LTE technology, the above embodiments may also apply to any other present or future 3GPP technology, such as LTE-advanced, and/or fourth generation (4G) technology.

### Partial Glossary

3GPP 3rd Generation Partnership Project
5G 5th Generation
5GCN 5G Core Network
BS Base Station
DL Downlink
eNB Enhanced Node B
gNB 5G or Next Generation NodeB
LTE Long Term Evolution
NR New Radio
RA Random Access
RedCap Reduced Capability
RLM Radio Link Monitoring
RRC Radio Resource Control
RRM Radio Resource Management
RSRP Reference Signals Received Power
SDT Small Data Transmission
UE User Equipment
UL Uplink

1. An apparatus, comprising:
at least one processor; and
at least one memory comprising computer program code, the at least one memory and the computer program code are configured, with the at least one processor, to cause the apparatus at least to
receive, at a reduced capability user equipment from a network element, a signal comprising information for a measurement relaxation;
determine whether the measurement relaxation is allowed based on the received information, the measurement relaxation being allowed based on subscription information about a mobility of the reduced capability user equipment; and
perform relaxed or non-relaxed measurements based on the determination.

2. The apparatus according to claim 1, wherein the measurement relaxation is not allowed when the reduced capability user equipment is mobile, near a cell edge, when a cell power or quality is low, or when a reference signal received power measurement is not static, and
wherein when the measurement relaxation is not allowed, the apparatus is further caused to ignore the information.

3. The apparatus according to claim 1, wherein the subscription information comprises an indication that the reduced capability user equipment is stationary.

4. The apparatus according to claim 1, wherein the measurement relaxation is achieved both in a time and frequency manner.

5. The apparatus according to claim 1, wherein reduced capabilities comprise one or more of Rx branches, Rx ports, Tx branches, reduced Tx power class, reduced processing capabilities, or reduced capability apparatus types.

6. The apparatus according to claim 1, wherein the signal is received via dedicated signaling or broadcast signaling.

7. The apparatus according to claim 1, wherein the information is targeted toward one or more radio resource control states comprising an idle state, an inactive state, and a connected state.

8. The apparatus according to claim 1, wherein the measurement relaxation is a radio link monitoring measurement relaxation or a radio resource management measurement.

9. An apparatus, comprising:
at least one processor; and
at least one memory comprising computer program code, the at least one memory and the computer program code are configured, with the at least one processor, to cause the apparatus at least to
configure a reduced capability user equipment by transmitting to the reduced capability user equipment a signal comprising information on whether a radio resource management measurement relaxation is allowed.

10. The apparatus according to claim 9, wherein the radio resource management measurement relaxation is not allowed when the user equipment is mobile, near a cell edge, when a cell power or quality is low, or when a reference signal received power measurement is not static.

11. The apparatus according to claim 9, wherein the signal is transmitted via dedicated signaling or broadcast signaling.

12. The apparatus according to claim 9, wherein the information is targeted toward one or more radio resource control states comprising an idle state, an inactive state, and a connected state.

13. The apparatus according to claim 9, wherein the at least one memory and the computer program code are further configured, with the at least one processor, to cause the apparatus at least to:
adjust measurement configuration criteria for a reduced capability user equipment,
wherein the adjustment comprises adjusting one or more of an addition or subtraction offset or multiplier for radio resource management or radio link monitoring relaxation parameters.

14. The apparatus according to claim 9, wherein the adjustment is performed for a relaxed measurement criterion for a reduced capability user equipment with a low mobility, or for a relaxed measurement criterion for a reduced capability user equipment located away from a cell edge.

15. The apparatus according to claim 9, wherein the at least one memory and the computer program code are further configured, with the at least one processor, to cause the apparatus at least to:
configure a reduced capability user equipment type or a number of Rx branch specific adjustments.

16. A method, comprising:
receiving, by a reduced capability user equipment from a network element, a signal comprising information for a measurement relaxation;
determining whether the measurement relaxation is allowed based on the received information, the measurement relaxation being allowed based on subscription information about a mobility of the reduced capability user equipment; and
performing relaxed or non-relaxed measurements based on the determination.

17. The method according to claim 16, wherein the measurement relaxation is not allowed when the reduced capability user equipment is mobile, near a cell edge, when a cell power or quality is low, or when a reference signal received power measurement is not static.

18. The method according to claim 16, wherein the subscription information comprises an indication that the reduced capability user equipment is stationary or low mobile.

19. The method according to claim 16, wherein the measurement relaxation is achieved both in a time and frequency manner.

20. The method according to claim 16, wherein the reduced capabilities comprise one or more of Rx branches, Rx ports, Tx branches, reduced Tx power class, reduced processing capabilities, or reduced capability user equipment types.

21. The method according to claim 16, wherein the signal is received via dedicated signaling or broadcast signaling.

22. The method according to claim 16, wherein the information is targeted toward one or more radio resource control states comprising an idle state, an inactive state, and a connected state.

23. The method according to claim 16, wherein the measurement relaxation is a radio link monitoring measurement relaxation or a radio resource management measurement.

24. A method, comprising:
configuring, by a network element, a reduced capability user equipment by transmitting to the reduced capability user equipment a signal comprising information on whether a radio resource management measurement relaxation is allowed.
